(19) United States
(12) Patent Application Publication
(10) Pub. No.: US 2006/0192163 A1
(43) Pub. Date: Aug. 31, 2006

(54) Fluid injection valve

(75) Inventors: Shinsuke Yamamoto, Kariya-city (JP); Yoshihisa Niimi, Nagoya-city (JP); Takayuki Hokao, Anjo-city (JP)

Correspondence Address: NIXON & VANDERHYE, PC, 901 NORTH GLEBE ROAD, 11TH FLOOR, ARLINGTON, VA, 22203, US

(73) Assignee: Denso Corporation, Kariya-city (JP)

(21) Appl. No.: 11/352,357

(22) Filed: Feb. 13, 2006

(30) Foreign Application Priority Data
Feb. 25, 2005 (JP) 2005-50571

(51) Int. Cl. F16K 31/02

(52) U.S. Cl. 251/129.21

(57) ABSTRACT

A fluid injection valve has a valve body, a fixed core, a moving core, a coil and a valve element. The valve element slides together with the moving core to open and close a valve seat. The valve element has an annular connection portion at an axial end portion thereof to be connected and fitted to an inner circumferential face of the moving core. The valve element forms an inner space therein to open to the moving core. A side wall of the valve element has a notch thereon at a downstream side of the annular connection portion to form a communication passage between the inner space and an outer space outside of the valve element.

### CROSS REFERENCE TO RELATED APPLICATION

This application is based upon and claims the benefit of priority of Japanese Patent Application No. 2005-050571 filed on Feb. 25, 2005, the content of which is incorporated herein by reference.

### FIELD OF THE INVENTION

The present invention relates to a fluid injection valve suitable for injecting fuel into cylinders of an internal combustion engine (hereinafter referred to just as engine).

### BACKGROUND OF THE INVENTION

U.S. Pat. No. 4,915,350 and its counterpart JP-H02-107877, for example, disclose a fuel injection valve provided with a communication passage penetrating a side wall of a valve member to communicate an inner space of the valve member with an outer space of the valve member. The fuel injection valve has such a construction that a slit extends over an entire axial length of a cylindrical element that forms the valve member and the communication passage penetrates the side wall of the cylindrical element. Further, as shown in FIG. 6, another fuel injection valve 300 is known in which a cup-like shaped valve element 310 has no slit and a communication passage 312 penetrates the side wall of the valve element 310.

However, in the fuel injection valve according to U.S. Pat. No. 4,915,350, the slit is formed to extend to a position in which the cylindrical element of the valve element is connected to an inner circumferential face of a moving core. Accordingly, the fuel injection valve has such an issue that a connection force decreases in press-fitting the valve element into the inner circumferential face of the moving core. Regarding the fuel injection valve 300 shown in FIG. 6, in forming the communication passage 312 penetrating the side wall of the valve element 310 that has no slit, it is known to use electric discharge machining or laser beam machining to form the communication passage 312. However, processing machines of the electric discharge machining or the laser beam machining to form the communication passage 312 increases manufacturing cost.

### SUMMARY OF THE INVENTION

The present invention is achieved in view of the above-described issue, and,has an object to provide a fluid injection valve that has a valve element firmly connected to a moving core and provided with a communication passage penetrating the side wall thereof in a relatively low-cost.

The fluid injection valve has a valve body, which has a valve seat, a fixed core, which is fixedly installed in the valve body, a moving core, which is slidably installed in the valve body to move in an axial direction of the valve body and to face the fixed core, a coil and a valve element. The coil generates a magnetic attraction force when it is energized between the fixed core and the moving core. The valve element is installed in the valve body to be slidable integrally with the moving core to be lifted off the valve seat to open the valve seat and to be seated on the valve seat to close the valve seat. The valve element has a side wall provided with an annular connection portion at an end portion thereof in the axial direction. The annular connection portion is connected and fitted to an inner circumferential face of the moving core. The valve element forms an inner space in the side wall to open to a side of the moving core. The side wall has a notch thereon at a downstream side of the annular connection portion to form a communication passage to communicate the inner space with an outer space outside of the valve element.

### BRIEF DESCRIPTION OF THE DRAWINGS

Features and advantages of embodiments will be appreciated, as well as methods of operation and the function of the related parts, from a study of the following detailed description, the appended claims, and the drawings, all of which form a part of this application. In the drawings:

FIG. 1A is a cross-sectional view showing a principal portion of a fluid injection valve according to a first embodiment of the present invention;

FIG. 1B is another cross-sectional view showing the principal portion of the fluid injection valve according to the first embodiment, which is taken along the line IB-IB of FIG. 1A;

FIG. 1C is still another cross-sectional view showing the principal portion of the fluid injection valve according to the first embodiment, which is taken along the line IC-IC of FIG. 1A;

FIG. 2 is a cross-sectional view showing an entire construction of the fluid injection valve according to the first embodiment;

FIG. 3A is a cross-sectional view showing a principal portion of a fluid injection valve according to a second embodiment of the present invention;

FIG. 3B is another cross-sectional view showing the principal portion of the fluid injection valve according to the second embodiment, which is taken along the line IIIB-IIIB of FIG. 3A;

FIG. 3C is still another cross-sectional view showing the principal portion of the fluid injection valve according to the second embodiment, which is taken along the line IIIC-IIIC of FIG. 3A;

FIG. 4A is a cross-sectional view showing a principal portion of a fluid injection valve according to a third embodiment of the present invention;

FIG. 4B is another cross-sectional view showing the principal portion of the fluid injection valve according to the third embodiment, which is taken along the line IVB-IVB of FIG. 4A;

FIG. 4C is still another cross-sectional view showing the principal portion of the fluid injection valve according to the third embodiment, which is taken along the line IVC-IVC of FIG. 4A;

FIG. 5A is a cross-sectional view showing a principal portion of a fluid injection valve according to a fourth embodiment of the present invention;

FIG. 5B is another cross-sectional view showing the principal portion of the fluid injection valve according to the fourth embodiment, which is taken along the line VB-VB of FIG. 5A;

FIG. 5C is still another cross-sectional view showing the principal portion of the fluid injection valve according to the fourth embodiment, which is taken along the line VC-VC of FIG. 5A; and

FIG. 6 is a cross-sectional view showing a conventional fluid injection valve.

### DETAILED DESCRIPTION OF PREFERRED EMBODIMENTS

### First Embodiment

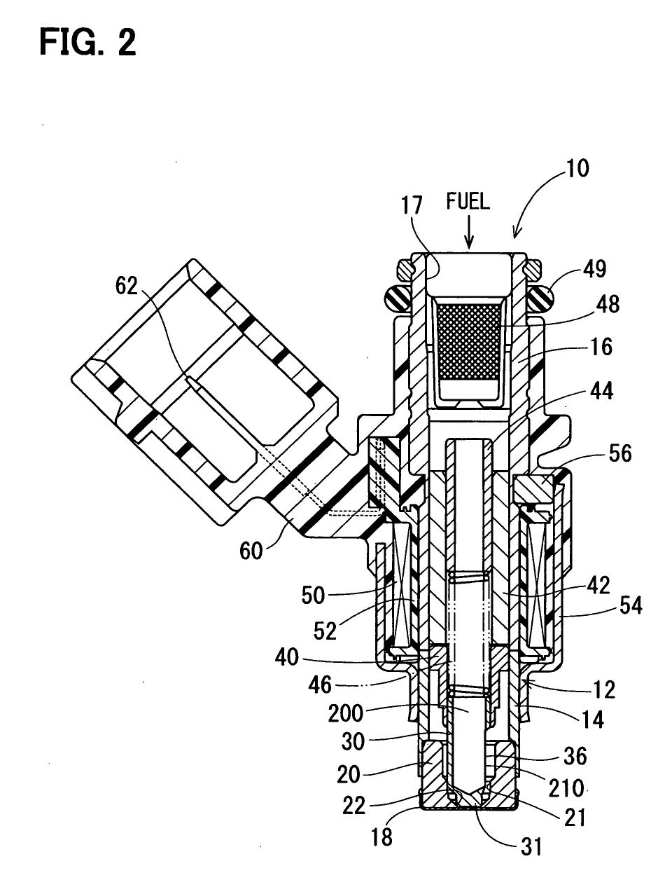

FIG. 2 depicts a fuel injection valve 10 according to a first embodiment of the present invention. The fuel injection valve 10 is installed in an intake pipe connected to a combustion chamber of a gasoline engine to inject fuel in an intake air flowing through an air intake passage formed by the intake pipe, for example. The fuel injection valve 10 is also applicable to a direct injection gasoline engine to inject fuel directly into the combustion chamber of the gasoline engine, or to a diesel engine.

A pipe member 12 includes a magnetic pipe 14 and a non-magnetic pipe 16, which are arranged in a line from the side of an injection port pate 18, on which injection holes are formed. The magnetic pipe 14 is connected to the non-magnetic pipe 16 by welding and the like. The pipe member 12 installs a valve body 20, a valve element 30, a moving core 40, a fixed core 42, an adjusting pipe 44, a spring 46 and a fuel filter 48 therein.

The magnetic pipe 14 retains the valve body in its inner circumferential face at its one end portion opposite from the non-magnetic pipe 16. The magnetic pipe 14 is connected to the valve body 20 by welding and the like. The non-magnetic pipe 16 extends to the other end of the fuel injection valve 10 opposite from the injection port plate 18, and provides a fuel inflow port 17 at the other end of the fuel injection valve 10. A fuel filter 48 is installed inside an inner circumferential face of the non-magnetic pipe 16 at the side of the fuel inflow port 17. The fuel filter 48 is for removing foreign matters contained in the fuel flown into the fuel injection valve 10 through the fuel inflow port 17. An O-ring 49, which serves as a seal member, is press-fitted onto an outer circumferential face of the non-magnetic pipe 16 at the side of the fuel inflow port 17.

The injection port plate 18 is connected to an external bottom face of the valve body 20 by welding and the like. On the injection port plate 18 is formed one or more injection ports to inject fuel therefrom.

On an inner circumferential face 21 of the valve body 20 is formed a valve seat 22, which is for seating the valve element 30 thereon. An inner diameter of the inner circumferential face 21 of the valve body 20 gradually decreases as going toward the injection holes. The valve element 30 is formed in a cup-like shape having a hollow and a contact portion 31 at a bottom portion thereof to be seated on the valve seat 22. The valve element 30 has an inner space 200 that is opened to the side of the moving core 40. The fuel flown from the side of moving core 40 into the inner space 200 further flows through a communication passage 210 outward to an outside of the valve element 30 to be lead to a valve portion formed from the contact portion 31 and the valve seat 22.

The moving core 40 is connected to the valve element 30 at an opposite side from the valve body 20 by welding and the like. A fixed core 42 is installed to face the moving core 40 at an opposite side from the valve seat 22, and fixed in the pipe member 12. An adjusting pipe 44 is press-fitted into the fixed core 42. Each of the moving core 40, the fixed core 42 and the adjusting pipe 44 is a cylindrical element opened to both sides in an axial direction of the fuel injection valve 10, to flow the fuel therethrough. A spring 46, which serves as an urging means, is installed in the moving core 40 and the fixed core 42 so that one end thereof is engaged with the valve element 30 and the other end thereof is engaged with the adjusting pipe 44. An urging force of the spring is adjusted by a press-fitting amount of the adjusting pipe 44 into the fixed core 42.

A coil 50 is repeatedly wound on a bobbin 52, and installed on an outer circumference of the pipe member 12. A yoke 54 covers an outer circumference of the coil 50, and is connected to the magnetic pipe 14 at a radially outside of the moving core 40. A yoke 56 is connected to a thin-walled portion of the non-magnetic pipe 16 at a radially outside of the fixed core 42. The two yokes 54, 56 are magnetically connected with each other. A resin housing 60 covers outer circumferences of the pipe member 12, the coil 50 and the yokes 54, 56. A terminal 62 is electrically connected to the coil 50 to supply driving current to the coil 50.

In the following is described a construction of the valve element 30 in detail.

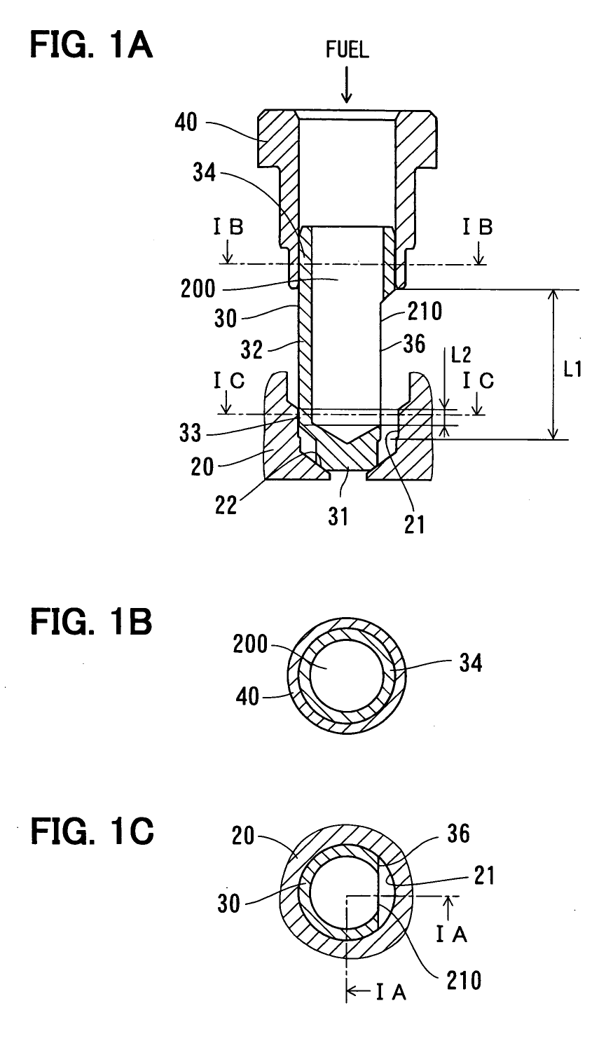

As shown in FIGS. 1A to 1C, the valve element 30 is formed in a cup-like shape. A side wall 32 of the valve element 30 has a sliding portion 33, which is slidably supported by the inner circumferential face of the 21 of the valve body 20, at an upstream side with respect to the contact portion 31. Further, the side wall 32 of the valve element 30 forms the inner space 200 therein to open to the side of the moving core 40. The side wall 32, which forms the inner space 200 therein, is press-fitted at the side of the moving core 40 into the inner circumferential face of the moving core 40, and fixed to the moving core by welding. The side wall 32 extends over an entire circumference of the valve element 30 at the portion connected to the inner circumferential face of the moving core 40, to form a cylinder-shaped annular connection portion 34.

The side wall 32 has a notch 36 that extend extends between the annular connection portion 34, which is positioned at a downstream end of the moving core 40, and the contact portion 31. The notch 36 is formed by removing a part of the side wall 32 by grinding, cutting and the like. The notch 36 provides the communication passage 210 to communicate the inner space 200 with the outer space of the valve element 30. The side wall 32 has a flat outer face at the portion in which the notch 36 is formed. The side wall 32 is removed from an upstream side to a downstream side at a position displaced in a circumferential direction of the valve element 30 from a position in which the sliding portion 33 is formed. Thus, an axial range L2 in which the sliding portion 33 is formed is within and smaller than an axial range L1 in which the notch 36 is formed.

A fluid passage area in a gap between a part of the notch 36, which is at the side of the sliding portion 33 in the circumferential direction of the valve element 30, and the inner circumferential face 21 of the valve body 20 is larger than an opening area between the contact portion 31 and the valve seat 22 when the valve element 30 is lifted at most. Accordingly, fuel injection amount is determined in accordance with the opening area between the contact portion 31 and the valve seat 22.

In the following is described an operation of the fuel injection valve 10.

When the coil 50 is energized, a magnetic field generated by the coil 50 forms a magnetic flux in a magnetic circuit formed from the yokes 54, 56, the magnetic pipe 14, the non-magnetic pipe 16, the moving core 40 and the fixed core 42. The non-magnetic pipe-16 is thin-walled at a portion connected to the yoke 56, so that the magnetic flux well passes between the yoke 56 and the fixed core 42 through the non-magnetic pipe 16. Thus, a magneto-resistance between the yoke 56 and the fixed core 42 is relatively small. The magnetic flux passing in the magnetic circuit generates a magnetic attraction force between the fixed core 42 and the moving core 40, so that the moving core 40 is attracted toward the fixed core 42. Then, the valve element 30 moves upward in FIG. 2 in accordance with the motion of the moving core 40 attracted toward the fixed core 42. Accordingly, the fuel flown from the fuel inflow port 17 in the pipe member 12 passes through the passages in the adjusting pipe 44, the fixed core 42 and the moving core 40, the inner space 200 of the valve element 30, the communication passage 210, an outer space of the valve element 30 and the gap between the contact portion 31 and the valve seat 22, to be injected from the injection holes formed on the injection port plate 18.

When the coil 50 stops being energized, the magnetic attraction force between the fixed core 42 and the moving core 40 extinguishes. As a result, the urging force of the spring 46 urges the moving core 40 apart from the fixed core 42. The valve element 30 also moves apart from the fixed core 42 toward the valve seat 22. When the contact portion 31 of the valve element 30 is seated on the valve seat 22, the fuel injection stops.

### Second, Third and Fourth Embodiments

In the following second, third and fourth embodiments of the present invention, the fuel injection valve 1 has a construction substantially as same as in the first embodiment and to the component elements thereof are assigned the referential numerals as same as in the first embodiment except valve element.

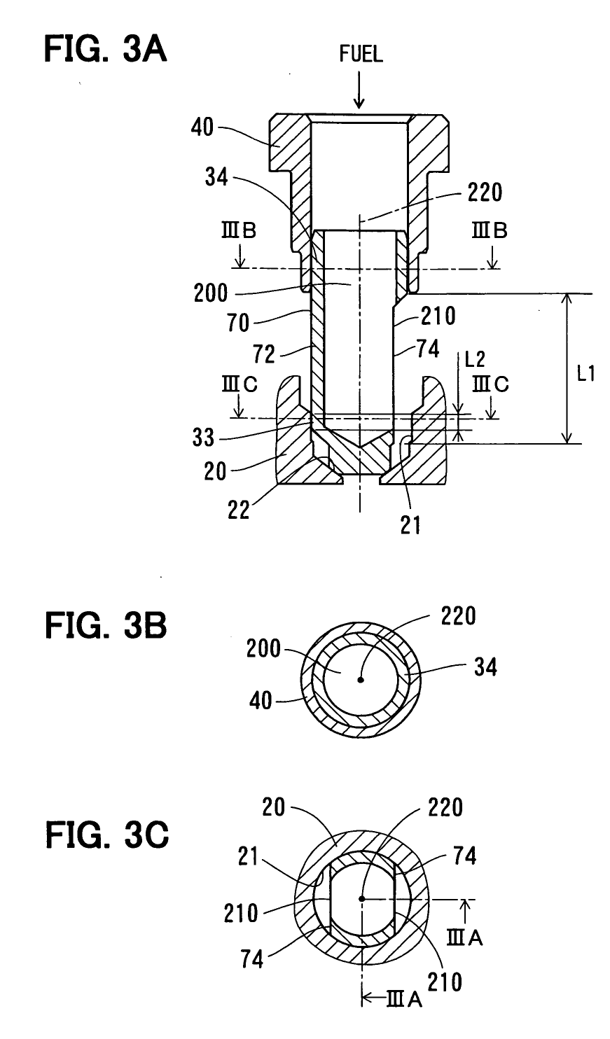

As shown in FIGS. 3A to 3C, the fluid injection valve 1 according to the second embodiment has a valve element 70 that has a pair of communication passages 210 on the side wall 72. The two communication passages 210 are symmetrically positioned about a central axis 220 of the valve element 70 and formed by removing two parts of the side wall 72. The side wall 72 is removed from an upstream side to a downstream side at two positions displaced in a circumferential direction of the valve element 70 from a position in which the sliding portion 33 is formed. An axial range L2 in which the sliding portion 33 is formed is within and smaller than an axial range L1 in which notches 74 is formed.

In the second embodiment, the communication passages 210 are symmetrically formed about the central axis 220 of the valve element 70. Thus, when the valve element 70 is lifted off the valve seat 22, reaction forces, which are applied by the fuel flowing from the inner space 200 through the communication passages 210 to the outer space of the valve element 70, are opposite from each other in a radial direction of the valve element 70 to cancel each other. Accordingly, in injecting the fuel, it is possible to prevent a radially eccentric force is prevented from acting onto the valve element 70, so that the valve element 70 is smoothly supported by the valve body 20 to move reciprocatingly in the axial direction.

Further, the fuel flows from the inner space of the valve element 70, then symmetrically passes through the communication passages 210 to the outer space of the valve element 70, to be injected. Thus, it is possible to prevent the fuel from being eccentrically injected about the central axis 220 of the valve element 70.

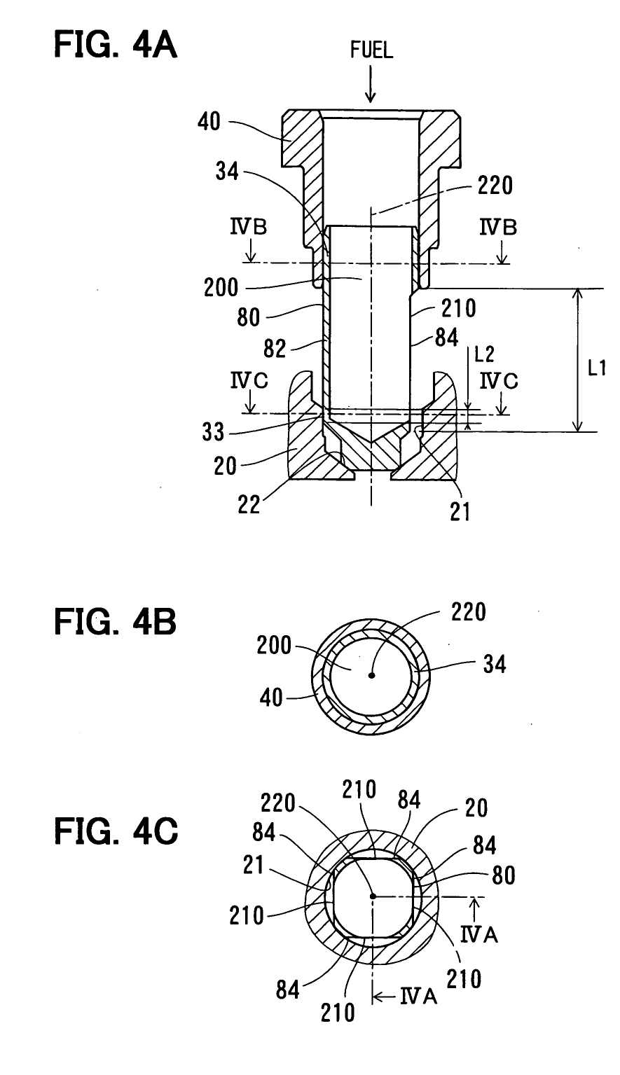

As shown in FIGS. 4A to 4C, the fluid injection valve 1 according to the third embodiment has a valve element 80 that has two pair of communication passages 210 on the side wall 82. The two communication passages 210 of each the pair are symmetrically positioned about a central axis 220 of the valve element 80 so that four communication passages 210 are disposed at every 90 degrees in a circumferential direction of the valve element 80. The side wall 82 is removed from an upstream side to a downstream side at four positions displaced by approximately 45 degrees in a circumferential direction of the valve element 80 from a position in which the sliding portion 33 is formed. Thus, an axial range L2 in which the sliding portion 33 is formed is within and smaller than an axial range L1 in which notches 84 is formed.

In the third embodiment, the communication passages 210 are symmetrically formed about the central axis 220 of the valve element 80 as in the second embodiment. Accordingly, in injecting the fuel, the valve element 80 is smoothly supported by the valve body 20 to move reciprocatingly in the axial direction. Further, it is possible to prevent the fuel from being eccentrically injected about the central axis 220 of the valve element 80.

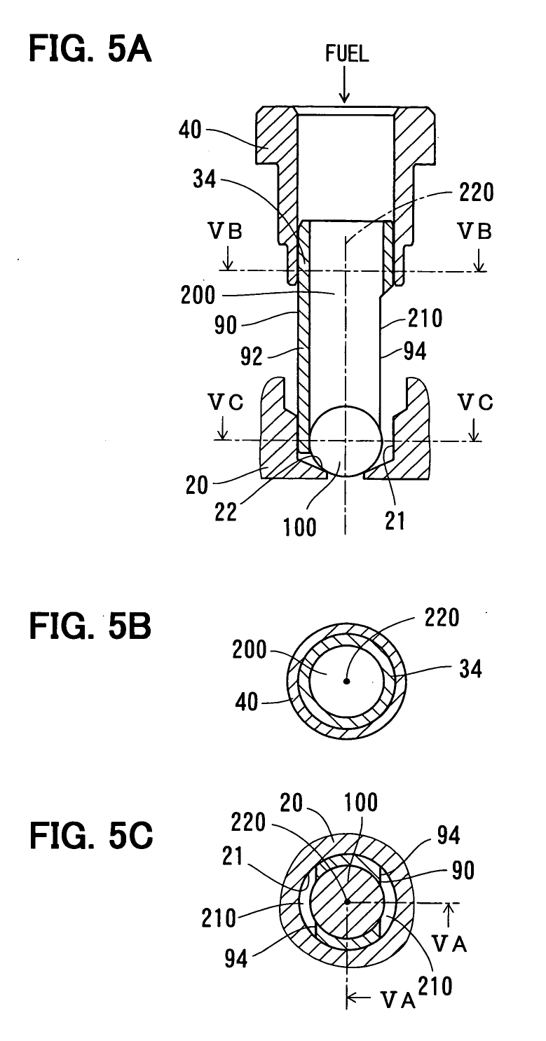

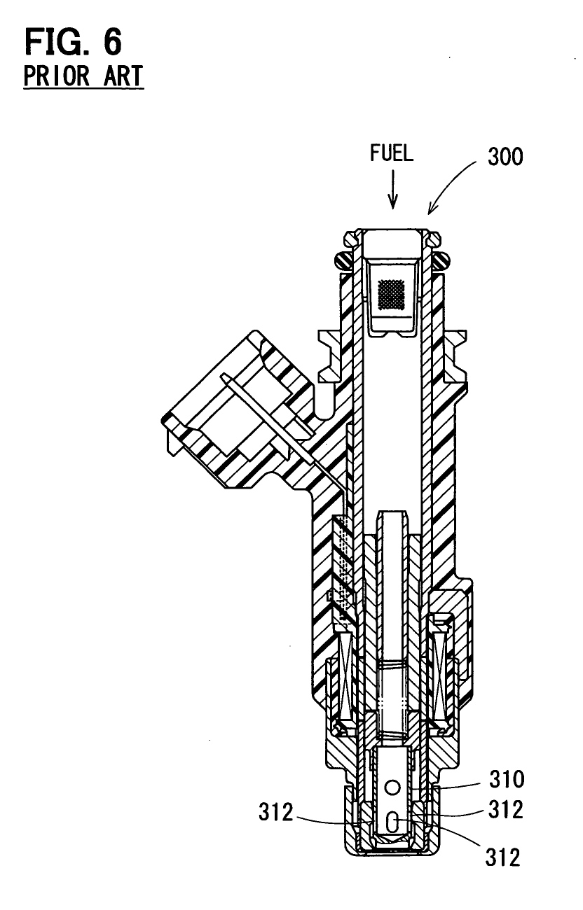

As shown in FIGS. 5A to 5C, the fluid injection valve 1 according to the fourth embodiment has a valve element formed from a cylindrical element 90 and a ball 100. The valve body 20 supports the cylindrical element 90 to be reciprocatingly slidable. The cylindrical element 90 has a pair of communication passages 210 on a side wall 92. The two communication passages 210 are symmetrically positioned about a central axis 220 of the cylindrical element 90 and the ball 100. That is, the two communication passages 210 are at opposite positions on the side wall 90 from each other in a radial direction of the cylindrical element 90.

In the fourth embodiment, the communication passages 210 are symmetrically formed about the central axis 220 of the cylindrical element 90 and the ball 100. Thus, in injecting the fuel, the cylindrical element 90 is smoothly supported by the valve body 20 to move reciprocatingly in the axial direction. Further, it is possible to prevent the fuel from being eccentrically injected about the central axis 220 of the cylindrical element 90 and the ball 100.

In the above-described first to fourth embodiments, the side wall is removed at a downstream side of the annular connection portion 34 to form the communication passages 210 to communicate the inner space 200 and the outer space of the valve element. As a result, the annular connection portion 34, which extends over the entire circumference of the valve element or the cylindrical element, is connected to the inner circumferential face of the moving core 40, so that it is possible to firmly connect the valve element to the moving core 40. The communication passages 210 are formed by removing some parts of the side wall of the valve element or the cylindrical element by machining works such as grinding, cutting and the like, so that it is possible to provide the communication passages 210 by using relatively low-cost processing machines.

Further, the fluid passage area in the gap between the notch and the inner circumferential face 21 of the valve body 20 is larger than the opening area between the contact portion 31 and the valve seat 22 when the valve element or the ball is lifted at most. Thus, the fuel injection amount is determined in accordance with the opening area between the contact portion 31 and the valve seat 22. It is easy to remove the side wall of the valve element or the cylindrical element to make the fluid passage area in the gap between the notch and the inner circumferential face 21 of the valve body 20 larger than the opening area between the contact portion 31 and the valve seat 22 when the valve element or the ball is lifted at most. Accordingly, it is not necessary to adjust a position and/or area of the notch with high precision in removing the side wall of the valve element or the cylindrical element, so that the communication passages 210 can be easily formed. In accordance with the easiness in the process to form the notches of the valve element, it becomes easy also to form the portions of the valve body 20 to support the sliding portion 33 of the valve element and the other portions of the valve body 20 other than the valve seat 22, so that the shape of the inner circumferential face 21 can be simplified.

### Other Embodiments

In the above-described first to fourth embodiments, the side wall of the valve element or the cylindrical element is removed from the upstream side to the downstream side. Alternatively, the notch may be formed to extend to an inside of the moving core 40, that is, to an upstream side of the downstream end of the moving core provided the side wall of the valve element or the cylindrical element extends over its entire circumference at least at a part in the axial range in which the side wall of the valve element or the cylindrical element is connected to the inner circumferential face of the moving core 40.

In the above-described fourth embodiment, the cylindrical element 90 of the valve element is supported by the valve body 20 to be reciprocatingly slidable. Alternatively, the valve element may be formed so that the ball 100 is supported by the valve body 20 to be reciprocatingly slidable.

This description of the invention is merely exemplary in nature and, thus, variations that do not depart from the gist of the invention are intended to be within the scope of the invention. Such variations are not to be regarded as a departure from the spirit and scope of the invention.

What is claimed is:

1. A fluid injection valve comprising:
a valve body that has a valve seat;
a fixed core that is fixedly installed in the valve body;
a moving core that is slidably installed in the valve body to move in an axial direction of the valve body and to face the fixed core;
a coil that generates a magnetic attraction force when it is energized between the fixed core and the moving core; and
a valve element that is installed in the valve body to be slidable integrally with the moving core to be lifted off the valve seat to open the valve seat and to be seated on the valve seat to close the valve seat, the valve element having a side wall provided with an annular connection portion at an end portion thereof in the axial direction to be connected and fitted to an inner circumferential face of the moving core and forming an inner space in the side wall to open to a side of the moving core, the side wall having a notch thereon at a downstream side of the annular connection portion to form a communication passage to communicate the inner space with an outer space outside of the valve element.

2. The fluid injection valve according to claim 1, wherein the valve element has a plurality of the communication passages that are approximately symmetrically disposed about a central axis of the valve element.

3. The fluid injection valve according to claim 1, wherein:
the side wall has a sliding portion that is supported by an inner circumferential face of the valve body to be slidable in the axial direction; and
the notch extends from a position upstream than the sliding portion to a position downstream than the sliding portion in the axial direction.

4. The fluid injection valve according to claim 3, wherein the sliding portion is formed at a position displaced from the communication passage in a circumferential direction of the side wall.

5. The fluid injection valve according to claim 1, the outer face of the side wall is approximately flat at the portion in which the notch is formed.

6. The fluid injection valve according to claim 1, wherein the valve element is formed from:
a cylindrical element that slides integrally with the moving core; and
a ball that is interposed between the cylindrical element and the valve seat to open and close the valve seat in accordance with a displacement of the cylindrical element.
